(19) United States
(12) Patent Application Publication
(10) Pub. No.: US 2008/0236916 A1
(43) Pub. Date: Oct. 2, 2008

(54) Drive train for a motor vehicle and method for operating a drive train

(76) Inventors: Marcus Heller, Farmington Hills, MI (US); Frank Hentschel, Sindelfingen (DE)

Correspondence Address: KLAUS J. BACH, 4407 TWIN OAKS DRIVE, MURRYSVILLE, PA, 15668, US

(21) Appl. No.: 12/069,435

(22) Filed: Feb. 8, 2008

Related U.S. Application Data
(63) Continuation-in-part of application No. PCT/EP2006/006943, filed on Jul. 15, 2006.

(30) Foreign Application Priority Data
Aug. 10, 2005 (DE) 10 2005 037713.0

(51) Int. Cl. B60K 6/20; B60L 11/12; H02P 3/14

(52) U.S. Cl. 180/65.4; 701/22

(57) ABSTRACT

In a drive train for a motor vehicle with an internal combustion engine and a serial hybrid drive and a method for operating a motor vehicle with such a drive train, wherein the driving performance is increased and the fuel consumption of the internal combustion engine is reduced, and the drive shaft of the internal combustion engine is connected to a first electrical machine, and a second electrical machine is connected to a drive wheel of the motor vehicle, an electrical energy accumulator to which electrical energy can be supplied by the first and second first electrical machines and which can supply electrical energy to the first and second electrical machine is provided together with a control unit for dividing the power between the electrical energy accumulator and the first electrical machine, the rotational speed (n) of the first electrical machine and the power of the internal combustion engine are controlled depending on vehicle operating conditions and energy accumulator states selectively for high fuel efficiency or low emissions.

This is a Continuation-in-Part Application of pending International patent application PCT/EP2006/006943 filed Jul. 15, 2006 and claiming the priority of German patent application 10 2005 037713.0 filed Aug. 10, 2005.

### BACKGROUND OF THE INVENTION

The invention relates to a drive train for a motor vehicle with an internal combustion engine and a serial hybrid drive and also to a method for operating a drive train of a motor vehicle with an internal combustion engine and a serial hybrid drive.

Motor vehicles with so-called serial hybrid drive are known. In these motor vehicles, during normal operation a first electrical machine is driven in a generating manner by an internal combustion engine and supplies electrical energy to an electrical energy accumulator, for example a traction battery. A second electrical machine fed by the electrical energy accumulator propels the motor vehicle via at least one driven wheel. In like manner, the second electrical machine may supply electrical energy to the energy accumulator as a generator in braking mode or in coasting mode.

DE 41 33 014 A1 discloses a motor vehicle with serial hybrid drive including first an second electric machines in which the rotational speed of the internal combustion engine is increased by the driver by opening the throttle when an increased power output is needed. It is additionally proposed to wholly or partially decouple electrically the first, generatively operated electrical machine from the second, electrical machine operated as a motor in order to increase the rotational speed of the internal combustion engine.

Controlling the rotational speed of the internal combustion engine via the fuel supply is disadvantageous, especially in driving cycles with frequent and rapid changes of engine speed, for example in urban traffic. For the dynamic operation of the internal combustion engine large fuel injection quantities are required for rapid increases in the rotational speed of the engine even at low engine speeds, since operations using the internal combustion engine requires relatively large fuel injection quantities which results, despite the relatively low dynamics, in high pollutant concentrations in the exhaust gas and to high fuel consumption.

It is the object of the present invention to provide a drive train and a method for operating a drive train of a motor vehicle in such a way that a high driving performance and/or low fuel consumption are attained.

### SUMMARY OF THE INVENTION

In a drive train for a motor vehicle with an internal combustion engine and a serial hybrid drive and a method for operating a motor vehicle with such a drive train, wherein the driving performance is increased and the fuel consumption of the internal combustion engine is reduced, and the drive shaft of the internal combustion engine is connected to a first electrical machine, and a second electrical machine is connected to a drive wheel of the motor vehicle, an electrical energy accumulator to which electrical energy can be supplied by the first and second first electrical machines and which can supply electrical energy to the first and second electrical machine is provided together with a control unit for dividing the power between the electrical energy accumulator and the first electrical machine, the rotational speed (n) of the first electrical machine and the power of the internal combustion engine are controlled depending on vehicle operating conditions and energy accumulator states selectively for high fuel efficiency or low emissions.

The first electrical machine can advantageously be operated in a highly dynamic, speed-controlled manner, making possible rapid adjustment of the rotational speed without assistance from the internal combustion engine. The rotational speed control of the first electrical machine also makes it possible to reliably limit of the rotational speed of the internal combustion engine in a coasting mode.

If a rectifier, which is not capable of energy regeneration, is used in place of an inverter in a drive train, the internal combustion engine cannot be started by the first electrical machine. For this reason it is necessary, as with a conventional drive, to operate the internal combustion engine in idle mode even if no energy is demanded. A start-stop mode cannot therefore be implemented.

With the present invention, a start-stop mode can advantageously be implemented in a simple manner without structural switching in the control system solely by specifying a suitable control variable for controlling the rotational speed of the first electrical machine.

In the inventive method for operating a drive train with an internal combustion engine the output drive shaft of which is connected in a rotationally fixed manner to a first electrical machine; a second electrical machine which is connected mechanically to a driven wheel; an electrical energy accumulator to which energy can be supplied by the first and second electrical machines and which can supply electrical energy to the first and second electrical machines; and a control unit for distributing power between the electrical energy accumulator and the first electrical machine, the rotational speed of the first electrical machine and the power of the internal combustion engine are controlled.

The power or torque command to the internal combustion engine is implemented directly via injection of the needed fuel quantity while avoiding transient (over-enriched) states, without high emission and consumption values during runup to speed. It also determines the steady-state power management and thus the charging and discharging of the energy accumulator. The advantageous steady-state operation of the internal combustion engine at the best point or on the best curve can be predetermined directly by specifying the rotational speed by means of the first electrical machine and the associated injection quantity, which is either controlled via a characteristic curve or, in order to increase accuracy, via a superposed power or torque control system. In two-point operation the internal combustion engine is operated either at the best point with highest efficiency or it is at a standstill, whereas with demand-controlled operation low loading on the energy accumulator is achieved together with good efficiency.

A switch between the two operating modes is preferably effected on the basis of optimization of the total losses of energy, accumulator and internal combustion engine/first electrical machine, while taking account of the desired mean charge state of the energy accumulator.

In the regenerative mode, in which the kinetic and/or potential energy of the vehicle is fed back into the electrical system and without fuel injection in coasting operation, the a power draw of the internal combustion engine can preferably be adjusted by the speed control system of the first electrical machine, in such a way that the charging of the electrical energy accumulator with charge current remains always within permitted specified limits.

In a particular embodiment of the invention, a voltage limiting control system or a charge current limiting control system is connected to the input of the speed control system of the first electrical machine. In this way the limit values of the electrical energy accumulator can be respected sufficiently rapidly and the use of the mechanical friction brake can be reduced, because it is needed only when a power equilibrium can no longer be maintained over an extended period.

Further advantages of the invention will become apparent from the following description of exemplary embodiments of the invention on the basis of the accompanying drawings:

### BRIEF DESCRIPTION OF THE DRAWING

FIG. 1 is a schematic representation of a drive train according to the invention;

FIG. 2 is a graph showing the power distribution in two-point operation of the internal combustion engine;

FIG. 3 is a graph showing the power distribution in demand-controlled operation of the internal combustion engine, and

FIG. 4 is a schematic representation of an inventive control system of the electrical machine connected to the internal combustion engine.

### DESCRIPTION OF PARTICULAR EMBODIMENTS

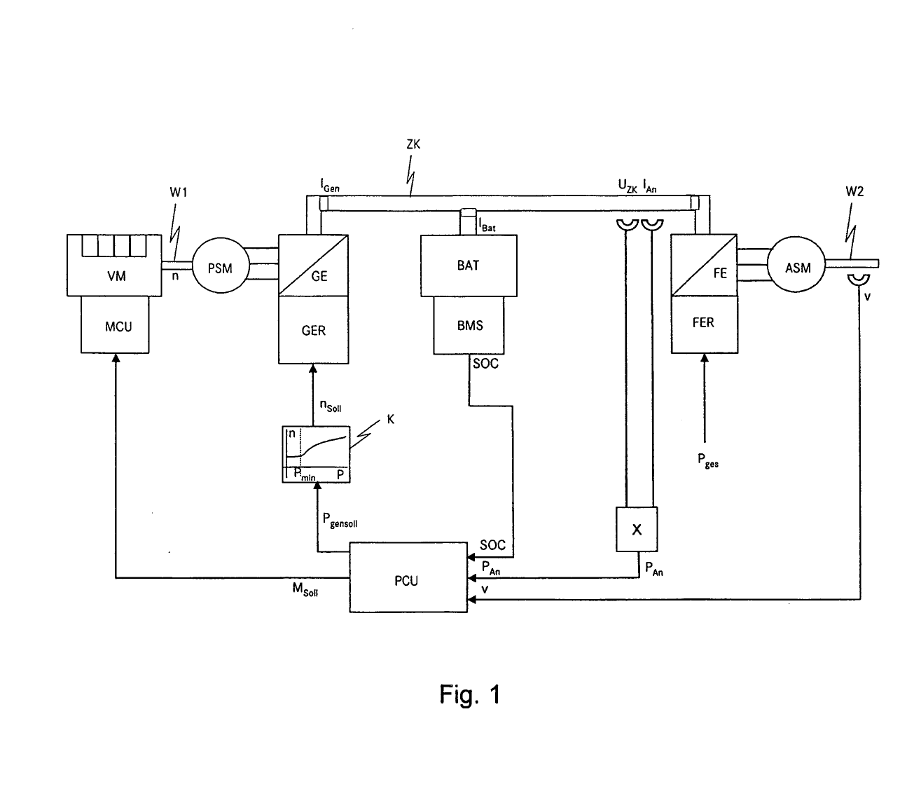

FIG. 1 shows an exemplary embodiment of a drive train according to the invention for a motor vehicle. In it the internal combustion engine VM is connected in a rotationally fixed manner via a drive shaft W1 to a first electrical machine PSM, preferably a permanently-excited synchronous machine. A second electrical machine ASM, preferably an asynchronous machine, is connected via a shaft W2 at least indirectly to a drive wheel (not shown). The second electrical machine ASM is preferably connected via the shaft W2 to an input shaft of a non-shiftable reduction gear. It is, however, also possible to connect the second electrical machine ASM mechanically to a transmission input shaft or transmission output shaft or directly to a driven axle or a wheel. It is also possible to provide a drive train according to the invention with a plurality of second electrical machines ASM.

The first electrical machine PSM is connected electrically via a first converter GE and the second electrical machine ASM via a second converter FE to an intermediate circuit ZK. An electrical energy accumulator BAT, when in the form of a battery, is preferably connected electrically directly to the intermediate circuit ZK. If a charge-dependent fluctuation of the accumulator voltage occurs, for example when the electrical energy accumulator BAT is in the form of a SuperCap, the electrical energy accumulator BAT may also be connected to the intermediate circuit ZK via a DC regulator. The converters GE, FE are preferably pulse-controlled converters.

In normal operation the first electrical machine PSM, driven by the internal combustion engine VM, supplies electrical energy to the battery BAT. The battery BAT in turn supplies electrical energy to the second electrical machine ASM which propels the vehicle. Likewise, the second electrical machine ASM can supply electrical energy as a generator to the battery BAT in braking or coasting mode. The converter FE of the second electrical machine ASM is controlled by a control device FER to which the reference drive torque M_{Asoll} requested by the driver, for example by means of the accelerator and brake pedals, is supplied.

A higher-ranking control unit PCU controls the distribution between the battery power P_{Bat} and the first electrical machine power P_{Gensoll}. Advantageously, a favorable, i.e. loss-minimizing, distribution is set in dependence on the operating state, an actual charge state SOC of the battery BAT, which is determined by a battery management system BMS, being maintained within a required range. In addition, the need to respect the permissible values for battery voltage U_{Bat} and battery current I_{Bat} is taken into consideration.

The power P_{Gensoll} of the internal combustion engine is calculated depending on the drive torque M_{Asoll} requested by the driver or on a drive power P_{An} resulting therefrom, on an actual load capacity of the battery BAT, determined by the battery management system BMS, which depends inter alia on the charge state SOC, and on a measured driving speed v of the vehicle. With regard to said power P_{Gensoll}, a favorable and if possible optimum rotational speed nₛₒₗₗ of the internal combustion engine VM and a required internal combustion engine torque Mₛₒₗₗ are determined according to an input-output map K of the internal combustion engine VM. The favorable rotational speed nₛₒₗₗ may be selected optimally with reference to consumption and/or optimally with reference to exhaust gas emissions. In particular, if required by the charge state SOC of the battery BAT, for example, the internal combustion engine VM may also be switched off during driving operation (start-stop mode). The fuel supply (injection) to the internal combustion engine VM is controlled according to the required torque Mₛₒₗₗ via the engine control unit MCU.

According to the invention the favorable rotational speed nₛₒₗₗ is set via a first speed regulator GER of the first electrical machine PSM and the power P_{Gensoll} via a fuel injection device on the internal combustion engine VM. The battery power P_{Bat} is then freely established according to the difference between the drive power P_{An}, which is yielded by the product of an intermediate circuit voltage U_{ZK} and a current I_{An} at the second electrical machine ASM, and the power output of the first electrical machine PSM.

If, for example, an increase in rotational speed is desired, this increase is set by the first speed regulator GER by means of a current I_{Gen} applied to the first electrical machine PSM, and the internal combustion engine power P_{Gensoll} is controlled by injection of the appropriate quantity of fuel.

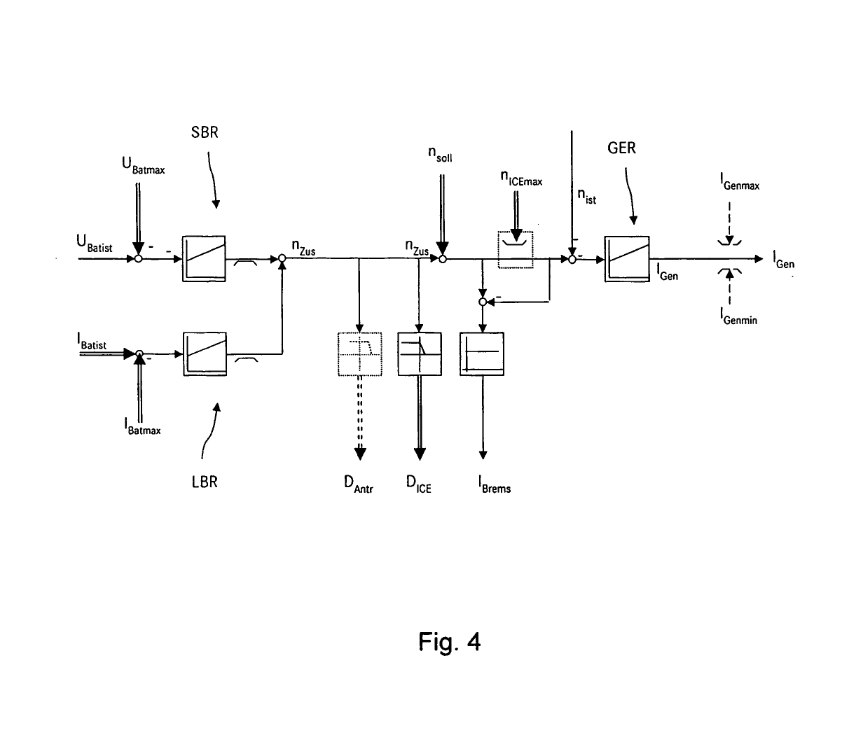

The exemplary embodiment of a drive train according to the invention shown in FIG. 1 is shown without protective and limitation functions. A limiting control system according to the invention for respecting the limit values of the battery BAT in controlling of the first electrical machine PSM is shown in FIG. 4.

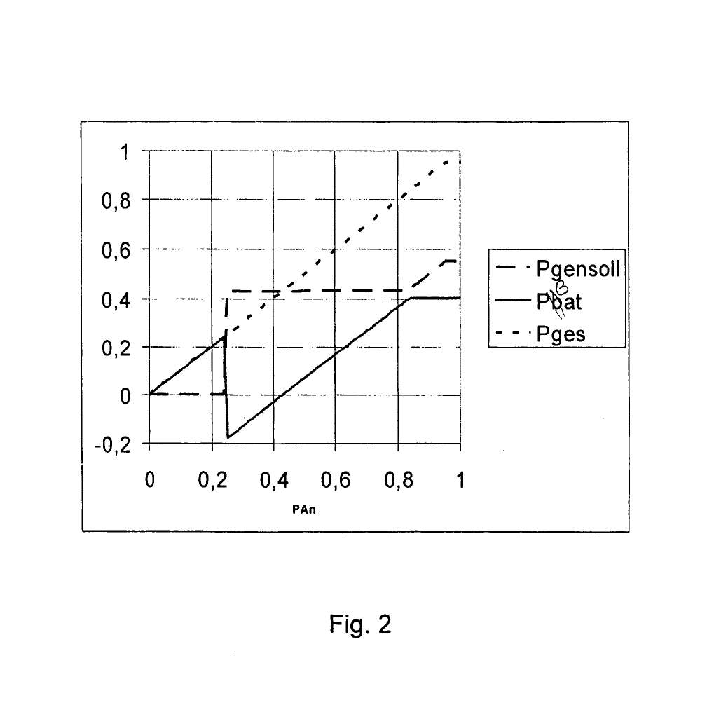

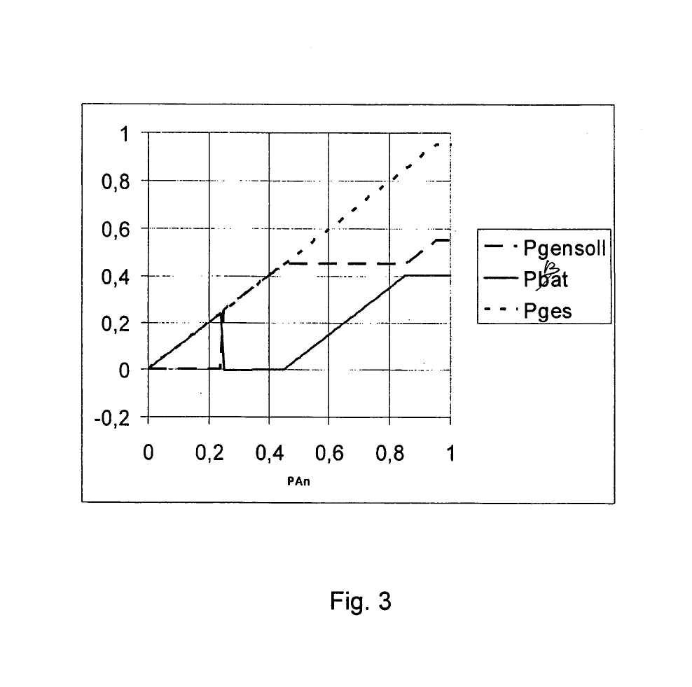

FIGS. 2 and 3 represent different operating modes of the power distribution by the control unit PCU.

With the power division shown in FIG. 2, the internal combustion engine VM is operated in a two-point mode. In this mode the internal combustion engine VM operates only at a best operating point or it is at a standstill. The required power P_{Gensoll} of the first electrical machine is shown depending on the power P_{An}, requested by the driver and the resulting power P_{Bat} provided by battery. If the requested power P_{An} is less than a defined minimum power, power P_{Bat} is drawn only from the battery and the internal combustion engine power P_{Gensoll} is zero, the internal combustion engine VM being at a standstill. Above the minimum power the internal combustion engine VM is started and operated at best point, the surplus power produced being utilized to charge the battery. Above best-point power both sources jointly supply the drive energy for the wheels. In the event of a very high power request P_{An} or of a low load capacity state of the battery BAT, a maximum power of the internal combustion engine VM is also provided.

With the power division shown in FIG. 3, the internal combustion engine VM is in a demand-controlled mode. In this operating mode the internal combustion engine VM is set to the best curve while operating with varying power P_{Gensoll} and varying rotational speed n. In this case, too, the internal combustion engine VM is started only above a minimum power demand. The internal combustion engine VM then supplies exactly the power P_{An} currently required by the vehicle, whereby additional charging or discharging of the battery BAT in the event of low drive power P_{An} is avoided. In this operating mode the mean charging of the battery BAT is less but the stress on the battery is also less. Only above the best-point power output do both sources again jointly supply the energy for driving the vehicle. In this case the battery is charged only in the regeneration mode of operation.

Through a continuous transition between the two operating modes and through a suitable selection of the minimum power, the mean charge state SOC of the battery BAT can be maintained at a desired value.

A switch between the two operating modes takes place, for example, depending on a loss-minimizing function. For example, it may be appropriate, in the event of discharge and charge losses of the battery BAT which are greater than the losses of the internal combustion engine VM in demand-controlled mode, to switch from two-point mode to demand-controlled mode of operation.

Respect for the limit values of the battery BAT can in principle be ensured only by the control unit PCU. According to the invention an especially fast-acting, higher-ranking limiting control system for controlling the first electrical machine PSM is provided, as shown in FIG. 4. The limit values of the electrical energy accumulator can thereby be respected sufficiently rapidly and the mechanical friction brake used more gently.

The protection against excess voltage when charging the battery BAT should become effective very quickly. To this end a voltage actual value U_{Batist}, which corresponds to the intermediate circuit voltage U_{ZK}, is measured in the first speed controller GER and compared to a currently permitted maximum value of the DC voltage U_{Batmax} (from the battery management system BMS) in a voltage limiting control system SBR connected to the input of the speed control system of the first electrical machine PSM. In addition, a charge current limiting controller LBR is provided, which intervenes in the event of excess charge current I_{Batist}, even if the voltage is not yet too high. The values of the actual charge current I_{Batist} and of a maximum permissible charge current I_{Batmax} are transmitted to the charge current limiting controller LBR of the battery management system BMS. If the battery voltage is excessive the voltage limiting controller SBR immediately specifies a rotational speed of the first electrical machine PSM increased by n_{zus}. A rotational speed increased by n_{zus} is also specified by the charge current limiting controller LBR in the event of excess battery current. As a result of the acceleration of the internal combustion engine VM and of the first electrical machine PSM caused thereby, energy is very rapidly withdrawn from the intermediate circuit ZK and temporarily stored in the rotating masses, so that this withdrawal of energy from the intermediate circuit ZK counteracts the excess voltage or excess current.

Simultaneously, a signal DICE is derived from the output of the voltage limiting controller SBR, with which signal, slightly delayed because of corresponding time delays over the CAN bus, any still effective injection of the internal combustion engine VM is ended and in addition a brake valve and/or a constant throttle is switched on as a function of the rotational speed. In the coasting mode thus activated the internal combustion engine VM absorbs braking power as a function of rotational speed and dissipates the resulting energy. The excess voltage or excess current in the intermediate circuit ZK is thereby further counteracted.

If the power to be absorbed is too great for the internal combustion engine VM, the first electrical machine PSM reaches a maximum permissible coasting speed n_{ICEmax}. The voltage limiting control SBR via the speed command, which has been described, is therefore no longer sufficient and a braking resistance which converts the excess energy into heat is additionally switched on. The power command for braking resistance, derived from the voltage limiting controller SBR, is effected via control of a corresponding current I_{Brems}.

If even this additional power is no longer sufficient, a downward-control signal D_{Antr} is derived from the voltage limiting controller SBR and transmitted to the second electrical machine ASM which propels the vehicle. The braking power which can be generated electrically is thereby limited. The difference between the available and the desired braking power must now be generated via conventional friction brakes.

The above-described procedure described for the case of excess voltage applies analogously to the presence of excess current.

The favorable rotational speed nₛₒₗₗ, possibly increased by a rotational speed n_{Zus}, or limited to the maximum permissible coasting speed n_{ICEmax}, is compared to an actual rotational speed nᵢₛₜ. From this the first speed controller GER determines a first torque-generating current I_{Gen} applied to the first electrical machine PSM. In engine-driven mode this is limited to a maximum value I_{Genmax}. In the power generation mode, however, it is limited to a minimum value I_{Genmin}.

What is claimed is:

1. A drive train for a motor vehicle with an internal combustion engine (VM) having an output drive shaft (W1), a first electrical machine (PSM) connected in a rotationally fixed manner to the output drive shaft (W1); a second electrical machine (ASM) connected mechanically to a vehicle drive wheel; an electrical energy accumulator (BAT) to which electrical energy can be supplied by the first and the second electrical machine (PSM, ASM) and which can supply electrical energy to the first and the second electrical machine (PSM, ASM); the electrical energy accumulator (BAT) being connected electrically via an intermediate circuit (ZK) to a first converter (GE) which is electrically connected to the first electrical machine (PSM), and to a second converter (FE) which is electrically connected to the second electrical machine (ASM), the first converter (GE) being connected via a control line to a first speed controller (GER), and a supervisory control unit (PCU) for distributing power (P_{Bat}) and (P_{Gensoll}) between the electrical energy accumulator (BAT) and the first electrical machine (PSM), and operating the internal combustion engine (VM), the electric machines (PSM<ASM) and the electrical energy accumulator (BAT) selectively for high fuel efficiency or low emissions.

2. The drive train as claimed in claim 1, wherein the internal combustion engine (VM) is connected to an engine control unit (MCU) which sets the power (P_{Gensoll}) to be generated by the internal combustion engine power.

3. The drive train as claimed in claim 1, wherein a limiting controller (SBR, LBR) is connected to the input of the first speed controller (GER).

4. The drive train as claimed in claim 1, wherein the second electrical machine (ASM) is connected mechanically to a transmission input shaft.

5. A method for operating a drive train for a motor vehicle with an internal combustion engine (VM), comprising an output drive shaft (W1) which is connected in a rotationally fixed manner to a first electrical machine (PSM), a second electrical machine (ASM) which is connected mechanically to a drive wheel of the vehicle, an electrical energy accumulator (BAT) to which electrical energy can be supplied by the first and the second electrical machines (PSM, ASM) and which can supply electrical energy to the first and the second electrical machines (PSM, ASM), and a control unit (PCU) for distributing power between the electrical energy accumulator (P_{Bat}) and the first electrical machine (P_{Gensoll}), comprising the step of: controlling a rotational speed (n) of the first electrical machine (PSM) and the power output (P_{Gensoll}) of the internal combustion engine.

6. The method as claimed in claim 5, wherein, for a desired change of rotational speed of the internal combustion engine (VM), the rotational speed (n) of the first electrical machine (PSM) and the power of the internal combustion engine (P_{Gensoll}) are controlled.

7. The method as claimed in claim 6, comprising the following steps:
determining of the required internal combustion engine power output (P_{Gensoll}) depending on a requested drive power (P_{An}), on a load capacity of the electrical energy accumulator (BAT) and on a driving speed (v) of the motor vehicle;
determining a favorable rotational speed (nₛₒₗₗ) of the internal combustion engine (VM) and a required fuel supply, and
setting the favorable rotational speed (nₛₒₗₗ) of the engine by way of the first electrical machine (PSM) controlled by a first speed controller (GER) and of the internal combustion engine power (P_{Gensoll}) by injection of the required quantity of fuel.

8. The method as claimed in claim 5, wherein the power output (P_{Gensoll}) of the internal combustion engine is set to provide an essentially steady-state operation.

9. The method as claimed in claim 5, wherein the internal combustion engine (VM) is operated in a two-point mode.

10. The method as claimed in claim 5, wherein the internal combustion engine (VM) is operated in demand-controlled mode.

11. The method as claimed in claim 5, wherein the internal combustion engine (VM) is operated selectively in a two-point mode or in a demand-controlled mode.

12. The method as claimed in claim 5, wherein the rotational speed (n) of the first electrical machine (PSM) is increased by a limiting controller (SBR, LBR).

13. The method as claimed in claim 12, wherein after a maximum permissible coasting rotational speed (n_{ICEmax}) has been reached a current (I_{Brems}) of a braking resistance is controlled by the limiting controller (SBR, LBR).
